(19) United States
(12) Patent Application Publication
(10) Pub. No.: US 2026/0078567 A1
(43) Pub. Date: Mar. 19, 2026

(54) Control System of Work Machine

(71) Applicant: Hitachi Construction Machinery Co., Ltd., Taito-ku, Tokyo (JP)

(72) Inventors: Tsuyoshi YAMADA, Tsuchiura-shi (JP); Seiji HIJIKATA, Tsuchiura-shi (JP)

(21) Appl. No.: 19/110,147

(22) PCT Filed: Feb. 27, 2024
(86) PCT No.: PCT/JP2024/007089

§ 371 Date: Mar. 10, 2025

(30) Foreign Application Priority Data
Feb. 27, 2023 (JP) 2023-028903

(51) Int. Cl. E02F 9/22; E02F 9/26; F15B 15/18; F15B 19/00

(52) U.S. Cl. CPC E02F 9/2203; E02F 9/2296; E02F 9/26; F15B 15/18; F15B 19/00; E02F 9/2285; E02F 9/2292

(57) ABSTRACT

A control system of a work machine includes a hydraulic pump that is rotationally driven by a prime mover and supplies hydraulic operating oil to a hydraulic actuator, a displacement control unit that controls the displacement of the hydraulic pump according to a control input, a displacement sensor that senses a displacement actual measured value of the hydraulic pump, and a controller that acquires a displacement target value of the hydraulic pump and outputs the control input according to the displacement target value to the displacement control unit. A mathematical model for predicting the displacement of the hydraulic pump is stored in the controller. The controller computes a displacement predicted value of the hydraulic pump by using the mathematical model and computes the optimum control input on the basis of the displacement predicted value and a constraint on the control input. The controller computes an evaluation value on the basis of the displacement target value and the displacement actual measured value and changes the constraint on the control input depending on the evaluation value.

### TECHNICAL FIELD

The present invention relates to a control system of a work machine.

### BACKGROUND ART

In a work machine such as a hydraulic excavator, a hydraulic pump whose displacement can be changed is used as a hydraulic fluid supply source for driving a hydraulic actuator. Patent Document 1 discloses a work machine that includes a motor driven by a fluid delivered from a swash plate type hydraulic pump and travels by power of the motor. The work machine described in Patent Document 1 sets a target position of a swash plate of the hydraulic pump on the basis of the position of an operation component and a load on an engine, and controls a hydraulic static transmission (HST) such that the position of the swash plate of the pump corresponds with the set target position.

### PRIOR ART DOCUMENT

### Patent Document

Patent Document 1: JP-2020-18171-A

### SUMMARY OF THE INVENTION

### Problem to be Solved by the Invention

A deviation between the actual displacement and a targeted displacement of the hydraulic pump affects the accuracy of control of a hydraulic actuator, and the accuracy of control of the hydraulic actuator affects work performance of the work machine. Thus, it is demanded to cause the actual displacement to rapidly follow the targeted displacement when the displacement of the hydraulic pump is changed.

An object of the present invention is to improve the responsiveness of displacement control for a hydraulic pump to achieve improvement in work performance of a work machine.

### Means for Solving the Problem

A control system of a work machine according to an aspect of the present invention includes a hydraulic pump that is rotationally driven by a prime mover and supplies hydraulic operating oil to a hydraulic actuator, a displacement control unit that controls the displacement of the hydraulic pump according to a control input, a displacement sensor that senses a displacement actual measured value of the hydraulic pump, and a controller that acquires a displacement target value of the hydraulic pump and outputs the control input according to the displacement target value to the displacement control unit. A mathematical model for predicting the displacement of the hydraulic pump is stored in the controller. The controller is configured to compute a displacement predicted value of the hydraulic pump by using the mathematical model and compute the control input that is optimum, on the basis of the displacement predicted value and a constraint on the control input. The controller is configured to compute an evaluation value on the basis of the displacement target value and the displacement actual measured value and change the constraint on the control input depending on the evaluation value.

### Advantages of the Invention

According to present invention, it is possible to improve the responsiveness of displacement control for the hydraulic pump to achieve improvement in work performance by the work machine.

### BRIEF DESCRIPTION OF THE DRAWINGS

FIG. 1 is a diagram depicting a system configuration of a work machine.

FIG. 2 is a sectional view of a main pump.

FIG. 3 is a characteristic diagram of an electrical signal and an output pressure of a solenoid proportional pressure reducing valve.

FIG. 4 is a control block diagram of control of a control target by model predictive control.

FIG. 5 is a flowchart of the model predictive control executed by a pump controller according to a first embodiment.

FIG. 6 is a time-series waveform diagram of control input constraints set by the pump controller according to the first embodiment.

FIG. 7 is a diagram depicting a time-series change in a displacement in a pump system according to the first embodiment.

FIG. 8 is a flowchart of model predictive control executed by the pump controller according to a second embodiment.

FIG. 9 is a time-series waveform diagram of the control input constraints set by the pump controller according to the second embodiment.

FIG. 10 is a diagram depicting a time-series change in the displacement in the pump system according to the second embodiment.

FIG. 11 is a diagram depicting a time-series change in the displacement in the pump system according to a modification of the second embodiment.

FIG. 12 is a flowchart of model predictive control executed by the pump controller according to a third embodiment.

FIG. 13 is a diagram depicting a time-series change in the displacement in the pump system according to the third embodiment.

### MODES FOR CARRYING OUT THE INVENTION

Embodiments of the present invention are described with use of the drawings.

### First Embodiment

### —Work Machine—

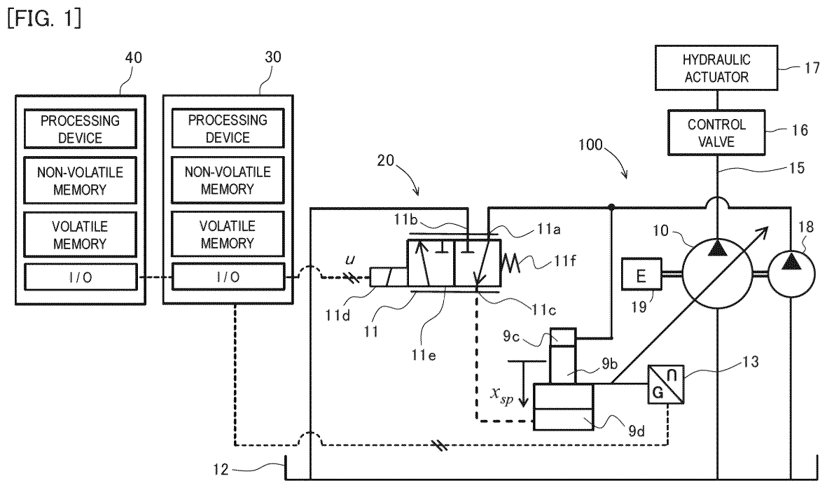

FIG. 1 is a diagram depicting a system configuration of a work machine. In FIG. 1, one of a plurality of hydraulic actuators 17 included in the work machine is depicted as a representative. The work machine according to the present embodiment is, for example, a hydraulic excavator including a track structure, a swing structure swingably attached to the track structure, and a work device attached to the swing structure. The work device includes a boom, an arm, a bucket, and a plurality of hydraulic cylinders that drive them. Further, the work machine includes a hydraulic motor for swinging that swings the swing structure and a hydraulic motor for travelling that causes the track structure to travel. The plurality of hydraulic cylinders that drive the work device, the hydraulic motor that drives the swing structure, and the hydraulic motor that drives the track structure are each the hydraulic actuator 17 disposed in the work machine.

### —Pump System (Control System of Work Machine)—

The hydraulic actuator 17 of the work machine is driven by hydraulic operating oil supplied from a pump system 100. As depicted in FIG. 1, a control valve 16 is disposed on a delivery line 15 that connects the hydraulic actuator 17 to the pump system 100. The control valve 16 is controlled according to the operation amount of an operation device that is not depicted in the work machine. By the control of the control valve 16, the flow rate and the direction of the hydraulic operating oil supplied from the pump system 100 to the hydraulic actuator 17 are controlled. Components such as the work device, the swing structure, and the track structure in the work machine are operated by the hydraulic actuator 17 being driven. Therefore, the pump system 100 has functions as a control system of the work machine.

The pump system 100 includes a main pump 10 that is a hydraulic pump whose displacement (capacity) can be changed, a displacement control unit 20 that controls the displacement of the main pump 10 according to a control input, a machine controller 40 that computes a displacement target value of the main pump 10, and a pump controller 30 that outputs, to the displacement control unit 20, the control input according to the displacement target value acquired from the machine controller 40. The main pump 10 is rotationally driven by an engine 19 that is a prime mover, and supplies the hydraulic operating oil (hydraulic operating fluid) to the hydraulic actuator 17. The pump system 100 includes a pilot pump 18 that is a hydraulic pump of the fixed displacement type separately from the main pump 10 of the variable displacement type. The pilot pump 18 is rotationally driven by the engine 19 and generates a pilot pressure. As the prime mover, an electrically driven motor may be employed instead of the engine 19.

### —Main Pump—

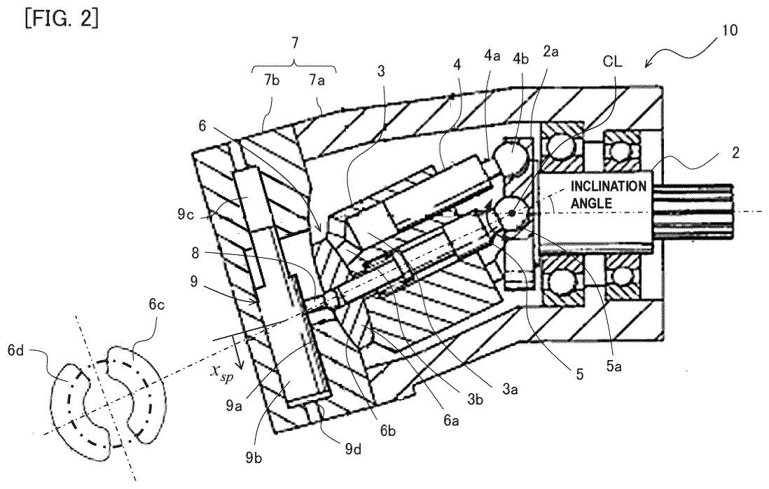

FIG. 2 is a sectional view of the main pump 10. The main pump 10 includes a casing 7, a cylinder block 3, a plurality of pistons 4, a tilting mechanism 6, and a tilting actuator 9. As depicted in FIG. 2, the main pump 10 according to the present embodiment is a bent axis type piston pump. However, the main pump 10 may be a swash plate type piston pump.

The casing 7 includes a main casing 7a and a head casing 7b. The main casing 7a is a cylindrical member that houses constituent components of the main pump 10, such as the cylinder block 3 and a rotating shaft 2. The tip (right end in FIG. 2) of the rotating shaft 2 protrudes from the casing 7, and is joined to an output shaft of the engine 19 (see FIG. 1). A drive disc 2a with a circular plate shape is integrally formed at the base end (left end in FIG. 2) of the rotating shaft 2. The rotating shaft 2 is supported rotatably relative to the main casing 7a by bearings. The head casing 7b closes an opening of the main casing 7a at an end portion thereof.

The cylinder block 3 is joined to the drive disc 2a with the interposition of a center shaft 5. The cylinder block 3 rotates together with the rotating shaft 2. A plurality of cylinder chambers 3a are formed in the cylinder block 3 along the axial direction of the cylinder block 3. These cylinder chambers 3a are annularly disposed to surround the rotation center line of the cylinder block 3. The piston 4 is inserted in the inside of each cylinder chamber 3a slidably back and forth. A connecting rod 4a is disposed at the base end (right end in FIG. 2) of each piston 4. A joint ball 4b is formed at the tip of each connecting rod 4a. The plurality of pistons 4 are each swingably joined to the drive disc 2a with the interposition of the joint ball 4b.

The tilting mechanism 6 is a mechanism that adjusts the stroke amount (pump capacity) of the piston 4 with respect to the cylinder chamber 3a. The tilting mechanism 6 includes a valve plate 6a having a sliding surface 6b with a cylindrical lens shape. The center shaft 5 and a swing pin 8 are respectively inserted into the center of the valve plate 6a from both sides thereof. The center shaft 5 penetrates the rotation center of the cylinder block 3, and is joined to the drive disc 2a. The center shaft 5 and the cylinder block 3 integrally rotate. The opposite surfaces of the valve plate 6a and the cylinder block 3 are rotational sliding surfaces, and the cylinder block 3 rotationally slides around the center shaft 5 relative to the valve plate 6a. Further, the tip (right end in FIG. 2) of the center shaft 5 has a joint ball 5a, and the center shaft 5 is swingably joined to the drive disc 2a with the interposition of this joint ball 5a.

The valve plate 6a has the sliding surface 6b that slides on a guide surface having a circular arc shape that is formed in the head casing 7b, and the cylinder block 3 and the valve plate 6a swing back and force to draw a circular arc trajectory around a swing center line CL passing through the center of the joint ball 5a. Moreover, in the valve plate 6a, ports (delivery port 6c and intake port 6d) that intermittently communicate with each cylinder chamber 3a by the rotation of the cylinder block 3 are made. The delivery port 6c communicates with the cylinder chamber 3a through a cylinder communication path 3b opposite to the delivery port 6c. The intake port 6d communicates with the cylinder chamber 3a through the cylinder communication path 3b opposite to the intake port 6d. When the inclination angle (tilting angle) of the rotation center line of the center shaft 5 with respect to the rotation center line of the rotating shaft 2 changes, the stroke amount (pump capacity) of the piston 4 with respect to the cylinder chamber 3a changes. That is, when the tilting angle changes, the amounts of supply and discharge of the hydraulic operating oil through the cylinder communication path 3b change.

The tilting actuator 9 is a displacement varying mechanism of a sector type. The tilting actuator 9 includes a cylinder chamber 9a formed in the head casing 7b and a servo piston 9b slidably inserted into the cylinder chamber 9a. The servo piston 9b reciprocates in the cylinder chamber 9a in the axial direction of the cylinder chamber 9a (axial direction of the servo piston 9b). The servo piston 9b is provided with the swing pin 8. The swing pin 8 is joined to the valve plate 6a. By action of the servo piston 9b in the axial direction, the valve plate 6a slides along the guide surface of the head casing 7b. That is, the tilting mechanism 6 operates and the tilting angle changes.

The inside of the cylinder chamber 9a is separated into two pressure receiving chambers 9c and 9d by the servo piston 9b. As depicted in FIG. 1, the pressure receiving chamber 9d is connected to the pilot pump 18 through a solenoid proportional pressure reducing valve 11. The pressure receiving chamber 9c is connected to the pilot pump 18 without through the solenoid proportional pressure reducing valve 11. A pilot primary pressure generated by the pilot pump 18 acts on the pressure receiving chamber 9c. In a state in which a pressure equivalent to that in the pressure receiving chamber 9c acts on the pressure receiving chamber 9d, the servo piston 9b moves in an upward direction in the diagram due to a difference in the pressure receiving area. When the pressure in the pressure receiving chamber 9d is reduced, the servo piston 9b moves in a downward direction in the diagram.

As depicted in FIG. 2, the servo piston 9b has a smaller-diameter portion and a larger-diameter portion. A step portion is formed between the smaller-diameter portion and the larger-diameter portion. The step portion of the servo piston 9b abuts against a step of the cylinder chamber 9a, and thereby one end (upper limit) of the movable range of the servo piston 9b is defined. Further, an end surface (lower end surface in the diagram) of the servo piston 9b abuts against an end portion (lower end in the diagram) of the cylinder chamber 9a, and thereby the other end (lower limit) of the movable range of the servo piston 9b is defined.

### —Operation of Main Pump—

When the rotating shaft 2 is rotationally driven by the engine 19, the cylinder block 3 joined to the drive disc 2a is also rotationally driven. In association with this, each piston 4 reciprocates in each of the cylinder chambers 3a of the cylinder block 3. Each piston 4 repeats an intake stroke and a delivery stroke. This causes the main pump 10 to deliver the hydraulic operating oil sucked from a tank 12 (see FIG. 1) from a delivery outlet as a hydraulic fluid.

The delivery flow rate of the main pump 10 is adjusted through change in the tilting angle. When the position of the servo piston 9b varies, the valve plate 6a moves along the guide surface of the head casing 7b. When the position of the valve plate 6a varies, the tilting angle changes. This varies the displacement amount of each piston 4 that slides in each of the cylinder chambers 3a. As a result, the flow rate delivered from the main pump 10 varies. When the servo piston 9b is displaced toward the side of the pressure receiving chamber 9c (upper side in the diagram), the tilting angle becomes smaller and the delivery flow rate of the main pump 10 becomes lower. On the other hand, when the servo piston 9b is displaced toward the side of the pressure receiving chamber 9d (lower side in the diagram), the tilting angle becomes larger and the delivery flow rate of the main pump 10 becomes higher.

### —Displacement Control Unit—

As depicted in FIG. 1, the displacement control unit 20 has the solenoid proportional pressure reducing valve 11. The solenoid proportional pressure reducing valve 11 has a pump port 11a, a tank port 11b, and a control pressure port 11c. The pump port 11a is connected to a delivery outlet of the pilot pump 18. The tank port 11b is connected to the tank 12 that stores the hydraulic operating oil. The control pressure port 11c is connected to the pressure receiving chamber (control pressure chamber) 9d of the tilting actuator 9. The solenoid proportional pressure reducing valve 11 includes a solenoid lid, a spool lie, and a spring 11f. The spring 11f biases the spool lie in such a direction as to be opposite to a thrust generated by the solenoid lid.

An electrical signal (electrical command signal) as the control input is input from the pump controller 30 to the solenoid proportional pressure reducing valve 11. The solenoid proportional pressure reducing valve 11 uses the delivery pressure (pilot primary pressure) of the pilot pump 18 as a source pressure to generate a pilot secondary pressure to be introduced to the pressure receiving chamber 9d on the larger-diameter portion side of the tilting actuator 9.

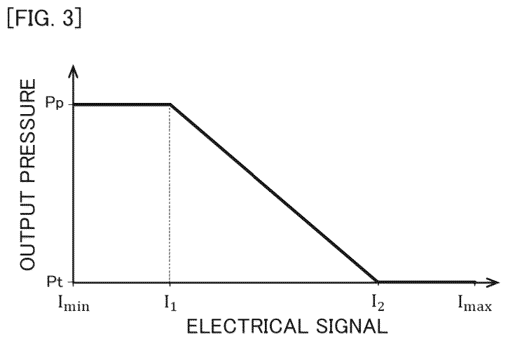

FIG. 3 is a characteristic diagram of the electrical signal and the output pressure of the solenoid proportional pressure reducing valve 11. As depicted in FIG. 3, a horizontal axis indicates the value of the electrical signal input to the solenoid lid of the solenoid proportional pressure reducing valve 11. The value of the electrical signal is, for example, the value of a control current (excitation current). A vertical axis indicates the pressure (pilot secondary pressure) output from the solenoid proportional pressure reducing valve 11 to the pressure receiving chamber (control pressure chamber) 9d.

When the electrical signal according to a pump displacement target value is input to the solenoid proportional pressure reducing valve 11 and the value of the electrical signal increases, the spool lie is displaced toward one side (right direction in FIG. 1), and the pressure receiving chamber (control pressure chamber) 9d communicates with the tank 12. Due to this, the pressure in the pressure receiving chamber 9d decreases, and a hydraulic load that acts on the larger-diameter portion of the servo piston 9b becomes lower relative to a hydraulic load that acts on the smaller-diameter portion of the servo piston 9b. Thus, the servo piston 9b is displaced toward one side (downward direction in FIG. 1). When the amount of displacement of the servo piston 9b in the downward direction from the upper limit position becomes larger, the displacement of the main pump 10 becomes larger. On the other hand, when the value of the electrical signal to the solenoid proportional pressure reducing valve 11 decreases, the spool lie is displaced toward the other side (left direction in FIG. 1), and the pressure receiving chamber (control pressure chamber) 9d communicates with the pilot pump 18. Due to this, the pressure in the pressure receiving chamber (control pressure chamber) 9d increases, and the hydraulic load that acts on the larger-diameter portion of the servo piston 9b becomes higher relative to the hydraulic load that acts on the smaller-diameter portion of the servo piston 9b. Thus, the servo piston 9b is displaced toward the other side (upward direction in FIG. 1). When the amount of displacement of the servo piston 9b in the upward direction from the lower limit position becomes larger, the displacement of the main pump 10 becomes smaller.

As depicted in FIG. 3, a correlation exists between the value of the electrical signal to the solenoid proportional pressure reducing valve 11 and the pilot secondary pressure output from the solenoid proportional pressure reducing valve 11, and an upper limit value and a lower limit value exist for the output pressure (control pressure of the tilting actuator 9) and the value of the electrical signal. In the present embodiment, the value of the electrical signal depicted in FIG. 3 is the value of the control current (excitation current) supplied to the solenoid lid of the solenoid proportional pressure reducing valve 11. In the solenoid proportional pressure reducing valve 11 of the present embodiment, a range of the control current value from a minimum current value Iₘᵢₙ to a first current value I₁ is set as a dead zone on the lower limit value side of the control input. That is, when the control current value is in a range equal to or larger than the minimum current value Iₘᵢₙ and equal to or smaller than the first current value I₁, the output pressure of the solenoid proportional pressure reducing valve 11 is a pilot primary pressure (upper limit value of the control pressure) Pp. Note that the minimum current value Iₘᵢₙ is 0 (zero) or a value of a standby current. In the solenoid proportional pressure reducing valve 11, a range of the control current value from a second current value I₂ to a maximum current value Iₘₐₓ is set as a dead zone on the upper limit value side of the control input. That is, when the control current value is in a range equal to or larger than the second current value I₂ and equal to or smaller than the maximum current value Iₘₐₓ, the output pressure of the solenoid proportional pressure reducing valve 11 is a tank pressure (lower limit value of the control pressure) Pt. When the control current value is in a range larger than the first current value I₁ and smaller than the second current value I₂, the output pressure becomes lower as the control current value increases.

### —Displacement Sensor—

As depicted in FIG. 1, a position sensor 13 that senses the position (displacement amount xₓₚ from a reference position) of the servo piston 9b is connected to the servo piston 9b. The reference position is, for example, a position with which the step portion of the servo piston 9b abuts against the step of the cylinder chamber 9a. The position sensor 13 outputs the sensed position of the servo piston 9b to the pump controller 30. As described later, the position of the servo piston 9b has a correlation with the actual displacement of the main pump 10. That is, the position sensor 13 functions as a displacement sensor that senses the actual displacement (displacement actual measured value) of the main pump 10.

The pump controller 30 is connected to the machine controller 40. The machine controller 40 computes a target value (hereinafter, referred to also as displacement target value) g_{ref} of the displacement of the main pump 10, and outputs the computation result to the pump controller 30.

### —Hardware Configuration of Controller—

The pump controller 30 is configured by a computer including a processing device such as a CPU (Central Processing Unit), an MPU (Micro Processing Unit), or a DSP (Digital Signal Processor), a non-volatile memory such as a ROM (Read Only Memory), a flash memory, or a hard disk drive, a volatile memory referred to as what is called a RAM (Random Access Memory), an input/output interface, and other peripheral circuits. These pieces of hardware cooperate with each other to operate software and implement a plurality of functions. The controller 30 may be configured by one computer, or may be configured by a plurality of computers.

Programs that can execute various computations, various thresholds, data tables, mathematical models, and the like are stored in the non-volatile memory. The non-volatile memory is a storage medium (storage device) that can read programs that implement functions of the present embodiment. The volatile memory is a storage medium (storage device) that temporarily stores a computation result obtained by the processing device and a signal input from the input/output interface. The processing device is a device that loads the program stored in the non-volatile memory into the volatile memory and executes computation, and executes predetermined computation processing for data taken in from the input/output interface, the non-volatile memory, and the volatile memory in accordance with the program.

An input section of the input/output interface converts a signal input from various devices (position sensor 13 and the like) to data that can be computed by the processing device. Moreover, an output section of the input/output interface generates a signal for output according to a computation result in the processing device, and outputs the signal to the various devices (solenoid proportional pressure reducing valve 11 and the like).

The machine controller 40 is configured by a computer including a processing device, a storage device (volatile memory and non-volatile memory), an input/output interface, and other peripheral circuits similarly to the pump controller 30.

### —Controller for Main Pump—

The machine controller 40 and the pump controller 30 according to the present embodiment function as a controller for the main pump 10. The controller for the main pump 10 changes the supply flow rate of the hydraulic operating oil from the main pump 10 to the hydraulic system for the purpose of improving the efficiency of the hydraulic system. This is implemented by varying the displacement (corresponding to the delivery flow rate per one rotation) of the main pump 10 depending on various operation states and operation conditions of the work machine.

### —Functions of Pump Controller—

In the pump controller 30, a conversion coefficient kₚᵤ for converting the position xₓₚ of the servo piston 9b to the actual displacement of the main pump 10 is stored. The conversion coefficient kₚᵤ is set in advance on the basis of a geometric relation between the position xₓₚ of the servo piston 9b and the constituent components of the main pump 10. The conversion coefficient kₚᵤ is a constant value. As the conversion coefficient, the variable kₚᵤ (xₛₚ) that varies depending on the position of the servo piston 9b may be employed. The pump controller 30 computes an actual displacement (displacement actual measured value) qₚ of the main pump 10 on the basis of the position xₓₚ of the servo piston 9b sensed by the position sensor 13 and the conversion coefficient kₚᵤ (qₚ=kᵤ·xₛₚ). The pump controller 30 controls the solenoid proportional pressure reducing valve 11 such that the displacement actual measured value qₚ comes closer to the displacement target value g_{ref} on the basis of the displacement target value g_{ref} and the displacement actual measured value qₚ of the main pump 10.

The pump controller 30 can adjust the tilting angle (displacement) of the main pump 10 by adjusting the value of the electrical signal input to the solenoid proportional pressure reducing valve 11. Here, when the value of the electrical signal input to the solenoid proportional pressure reducing valve 11 is increased, the servo piston 9b moves in such a direction as to increase the tilting angle. The servo piston 9b moves until the larger-diameter portion of the servo piston 9b abuts against the lower end surface of the cylinder chamber 9a. In contrast, when the value of the electrical signal input to the solenoid proportional pressure reducing valve 11 decreases, the servo piston 9b moves in such a direction as to decrease the tilting angle. The servo piston 9b moves until the step portion of the servo piston 9b abuts against the step of the cylinder chamber 9a. Therefore, for moving or holding the servo piston 9b to or at any position, the value of the electrical signal input to the solenoid proportional pressure reducing valve 11 is required to be sequentially changed.

A control pressure characteristic of the tilting actuator 9 differs between a case in which the hydraulic operating oil flows out from the pressure receiving chamber (control pressure chamber) 9d and a case in which the hydraulic operating oil flows into the pressure receiving chamber (control pressure chamber) 9d. Thus, the control pressure characteristic of the tilting actuator 9 is switched when a state transition is made between a state in which the hydraulic operating oil flows out from the pressure receiving chamber 9d and a state in which the hydraulic operating oil flows into the pressure receiving chamber 9d. Because the control pressure characteristic is switched as above, the control pressure characteristic of the tilting actuator 9 is a non-linear characteristic when the displacement actual measured value is close to the displacement target value.

The pump controller 30 computes a displacement deviation e that is a deviation between the displacement target value g_{ref} and the displacement actual measured value qₚ. The displacement deviation e corresponds to the absolute value of a value obtained by subtracting the displacement actual measured value qₚ from the displacement target value g_{ref} (e=|q_{ref}−qₚ|). The pump controller 30 inputs the displacement deviation e to a control system, and outputs the electrical signal to the solenoid lid of the solenoid proportional pressure reducing valve 11 as a control input u for making the displacement deviation e small.

A description is here given of the content of feedback control for the displacement by a pump controller according to a comparative example of the present embodiment and a problem that possibly occurs at the time. The pump controller according to the comparative example executes the feedback control for the displacement by using a control system in which no consideration is made about the upper limit value and the lower limit value of the value of the electrical signal to the solenoid proportional pressure reducing valve 11 and the change in the control pressure characteristic of the tilting actuator 9 when the displacement actual measured value is close to the displacement target value. A flow of specific control operation is as follows.

(Operation 1) The pump controller according to the comparative example outputs the electrical signal for increasing the displacement to the solenoid proportional pressure reducing valve 11 for controlling the tilting actuator 9. That is, the pump controller according to the comparative example increases the value of the electrical signal. (Operation 2) Due to the flowing-out of the hydraulic operating oil from the cylinder chamber 9a of the tilting actuator 9, the tilting actuator 9 moves in such a direction as to increase the displacement. (Operation 3) When the displacement actual measured value has reached the displacement target value, the pump controller according to the comparative example sets the value of the electrical signal for controlling the tilting actuator 9 to 0 (zero). (Operation 4) The tilting actuator 9 does not stay at a target position corresponding to the displacement target value and overshoots the target position to stop due to a characteristic of the electrical signal to the solenoid proportional pressure reducing valve 11, a characteristic in terms of the structure of the solenoid proportional pressure reducing valve 11, a characteristic in terms of the structure of the tilting actuator 9, the control pressure characteristic of the tilting actuator 9, and the like. Due to this, the displacement actual measured value becomes larger than the displacement target value. (Operation 5) Thus, the pump controller according to the comparative example outputs the electrical signal for decreasing the displacement to the solenoid proportional pressure reducing valve 11. That is, the pump controller according to the comparative example decreases the value of the electrical signal. (Operation 6) Due to the flowing of the hydraulic operating oil into the cylinder chamber 9a of the tilting actuator 9, the tilting actuator 9 moves in such a direction as to decrease the displacement. (Operation 7) Similarly to the above-described (Operation 3) and (Operation 4), the tilting actuator 9 does not stay at the target position corresponding to the displacement target value and overshoots the target position to stop. Due to this, the displacement actual measured value becomes smaller than the displacement target value. (Operation 8) When the above-described (Operation 1) to (Operation 7) are repeated from then on, the hydraulic operating oil of the cylinder chamber 9a of the tilting actuator 9 is subjected to switching between flowing-out and flowing-in, and thus the control pressure characteristic of the tilting actuator 9 is switched.

In the control by the pump controller according to the comparative example, factors given to the accuracy of tracking of the displacement actual measured value with respect to the displacement target value at the transient response, that is, factors in the non-linear characteristic of the pump displacement, include the existence of the dead zones in the control input corresponding to the upper and lower limits of the control pressure and the change in the control pressure characteristic of the tilting actuator 9 when the displacement actual measured value is close to the displacement target value. The dead zone existing in the control input is a factor in increase in an overshoot or an undershoot with respect to the displacement target value due to delay of switching of the control input. Further, the switching of the control pressure characteristic of the tilting actuator 9 between the characteristic when the hydraulic operating oil flows into the cylinder chamber 9a and the characteristic when the hydraulic operating oil flows out from the cylinder chamber 9a is a factor in increase in the duration and the oscillation amplitude of a hunting phenomenon (oscillation phenomenon) of the displacement actual measured value with respect to the displacement target value.

As described above, in the method in which the feedback control of the displacement actual measured value is executed by PI control or the like, there is a possibility that it is impossible to obtain favorable accuracy of tracking of the displacement actual measured value with respect to the displacement target value at the transient response. Thus, the present embodiment uses model predictive control that can reflect constraints on the control input (hereinafter, referred to also as control input constraints) at the design step of the control system and take in the control input constraints of the main pump 10 (upper limit value and lower limit value of the control input) as a condition at the time of calculation of the control input. The model predictive control is executed for the purpose of making the displacement deviation e small. Moreover, the control input constraints are made variable for the change in the control pressure characteristic of the tilting actuator 9 when the displacement actual measured value is close to the displacement target value. Thereby, shortening of a settling time at the transient response of the pump displacement control is promoted. If the settling time can be shortened, delay of operation of the hydraulic actuator can be suppressed, and improvement in work performance of the work machine using the hydraulic actuator can be achieved. The content of control by the pump controller 30 according to the present embodiment is described in detail below.

### —Model Predictive Control—

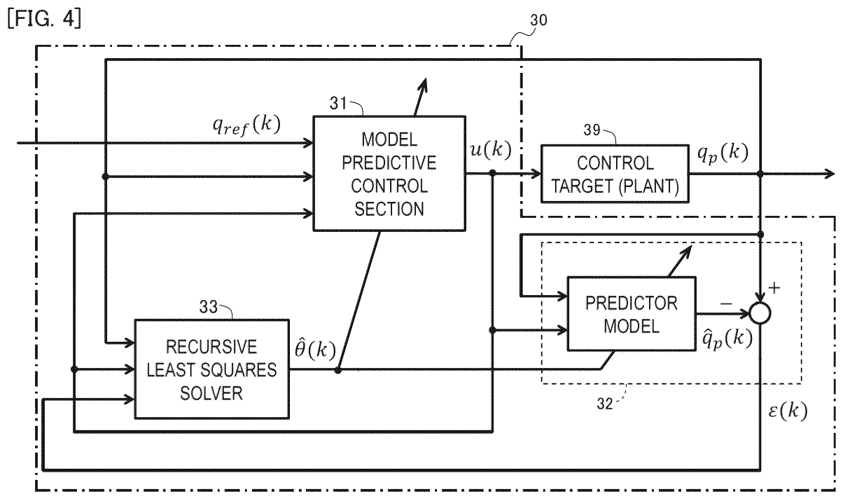

FIG. 4 is a control block diagram of control of a control target by the model predictive control. A control target (plant) 39 of a control system depicted in FIG. 4 is from the solenoid proportional pressure reducing valve 11 to the displacement of the servo piston 9b. When the electrical signal as the control input u(k) is input to the solenoid proportional pressure reducing valve 11 as the control target 39, the servo piston 9b is displaced by the output pressure of the solenoid proportional pressure reducing valve 11. The displacement of the servo piston 9b is converted to the displacement actual measured value qₚ of the main pump 10.

The machine controller 40 computes the displacement target value g_{ref} on the basis of the operation amount of an operation lever of the hydraulic actuator 17 and the delivery pressure of the main pump 10. The operation amount of the operation lever is sensed by an operation amount sensor. The delivery pressure of the main pump 10 is sensed by a delivery pressure sensor. The machine controller 40 may compute the displacement target value g_{ref} while taking into consideration also the speed of the hydraulic actuator 17, the angle and the position of a component driven by the hydraulic actuator 17, and the like. The machine controller 40 outputs the computed displacement target value g_{ref} to the pump controller 30.

The pump controller 30 has functions as a model predictive control section 31, a predictor 32, and a recursive least squares solver 33. The model predictive control section 31 computes the optimum control input u in real time by using the displacement target value g_{ref}, the displacement actual measurement value qₚ, the control input u computed in the previous control cycle, the control input constraints, and a mathematical model (hereinafter, referred to also as predictor model) for predicting behavior of the displacement of the main pump 10.

The predictor model is a physical model for predicting the displacement after the elapse of a predetermined time from the current time point (future displacement), and is represented by the following formula (1). The predictor model is stored in the non-volatile memory of the pump controller 30 in advance.

$$\begin{matrix}[ Formula 1 ] & \\ x ( k + 1 ) = Ax ( k ) + Bu ( k ) & ( 1 )\end{matrix}$$

$${q}_{p} ( k ) = Cx ( k )$$

In equation of state (1), x(k) is a state vector. Any structure can be designed as the structure of the state vector x(k). k represents the control cycle (step count) at the current time (computation time point). k+1 represents the control cycle subsequent to the current control cycle. A is a system matrix of the predictor model. B is a control input vector of the predictor model. C is an output vector of the predictor model. The matrix A and the vectors B and C are structures designed in conformity to the structure of the state vector x(k).

As parameters configuring the matrix A and the vectors B and C, that is, parameters of the predictor model, values acquired in advance by an identification method or the like or values updated in every sampling time by an adaptive identification method are used. In a case of acquiring the parameters by the identification method in advance, an average of a plurality of parameters obtained by varying at least either the load pressure (delivery pressure of the main pump 10) or the temperature of the hydraulic operating oil may be used as the parameters. This can reduce deviation of characteristics even when the operation environment changes. As a result, the tilting angle of the main pump 10 can be caused to accurately track the target value.

In the present embodiment, the state vector x(k) is represented by the following formula (2).

$$\begin{matrix}[ Formula 2 ] & \\ x ( k ) = {[ \begin{matrix}{q}_{p} ( k ) & {q}_{p} ( k - 1 )\end{matrix} ]}^{T} & ( 2 )\end{matrix}$$

In formula (2), qₚ(k) is a displacement actual measurement value obtained in the current control cycle, and qₚ(k−1) is a displacement actual measurement value obtained in the control cycle previous to the current control cycle.

The model predictive control section 31 and the predictor 32 compute a predicted value (hereinafter, referred to also as displacement predicted value) qₚ\hat{ } of the displacement of the main pump 10 by using the control input u(k), the displacement actual measured value qₚ(k), and the predictor model. The predictor 32 computes a predictive error ε(k) that is a deviation between the displacement actual measured value qₚ(k) and the displacement predicted value qₚ\hat{ }(k)=(ε(k)=qₚ(k)−qₚ\hat{ }(k)). The displacement predicted value qₚ\hat{ }(k) is represented by the following formula (3) with use of θ(k) that is a parameter of the predictor model and a regressor vector φ(k). The parameter θ(k) includes the parameters configuring the system matrix A, the control input vector B, and the output vector C of the predictor model.

$$\begin{matrix}[ Formula 3 ] & \\ {\hat{q}}_{p} ( k ) = θ ( k ) φ ( k ) & ( 3 )\end{matrix}$$

The regressor vector φ(k) is represented by the following formula (4) with use of the displacement actual measured value qₚ(k) and the control input u(k). The regressor vector φ(k) is a structure designed in conformity to the structure of the state vector x(k), and the description of formula (4) is one example.

$$\begin{matrix}[ Formula 4 ] & \\ φ ( k ) = {[ \begin{matrix}- {q}_{p} ( k - 1 ) & - {q}_{p} ( k - 2 ) & u ( k - 1 )\end{matrix} ]}^{T} & ( 4 )\end{matrix}$$

The recursive least squares solver 33 computes a parameter predicted value θ\hat{ }(k) that is the optimum value (predicted value) of the parameter θ(k) of the predictor model (mathematical model of the predictor) by a recursive least squares method in real time by using the displacement actual measured value qₚ(k), the control input u(k), and the predictive error ε(k). The recursive least squares solver 33 computes the parameter predicted value θ\hat{ }(k) of the predictor model such that the predictive error ε(k) computed by the predictor 32 comes closer to 0 (zero). Specifically, the recursive least squares solver 33 computes the parameter predicted value θ\hat{ }(k) by the following formula (5b) such that an evaluation function J_{θ}(k) represented by the following formula (5a) becomes the minimum.

$$\begin{matrix}[ Formula 5 ] & \\ {J}_{θ} ( k ) = \frac{1}{N} {\sum }_{k = 1}^{N} {ε}^{2} ( k ) & ( 5 a )\end{matrix}$$

$$\hat{θ} ( k ) = \hat{θ} ( k - 1 ) + {( {\sum }_{k = 1}^{N} φ ( k ) {φ}^{T} ( k ) )}^{- 1} φ ( k ) ε ( k ) \qquad ( 5 b )$$

The parameter predicted value θ\hat{ }(k) includes the parameters configuring the system matrix A, the control input vector B, and the output vector C. The regressor vector φ(k) is computed on the basis of the displacement actual measured value qₚ(k) and the control input u(k) as described above.

The recursive least squares solver 33 rewrites (overwrites) the parameters of the predictor model stored in the non-volatile memory to parameters included in the parameter predicted value θ\hat{ }(k) that is the computation result. Thereby, the matrix A and the vectors B and C of the predictor model used in the model predictive control section 31 and the predictor 32 are updated by the parameter predicted value θ\hat{ }(k) computed by the recursive least squares solver 33. This update processing is repeatedly executed at every calculation step. That is, the predictor model is updated by the recursive least squares solver 33 in real time. When the predictive error ε(k) is 0, the updating of the predictor model is not substantially executed.

Even when the predictor model is not updated, control of the displacement of the main pump 10 is possible. In this case, the parameters of the predictor model can be set on the basis of a test result under certain operation conditions. An average of a plurality of parameters computed depending on change in operation conditions such as the load pressure and the temperature of the hydraulic operating oil may be employed as the parameter of the predictor model. However, in the work machine such as a hydraulic excavator, the operation conditions (the load pressure and the temperature of the hydraulic operating oil), the actual displacement of the main pump 10, and the like always change during operation. Thus, if fixed values are employed as the parameters of the predictor model, the accuracy of the predictive control lowers. That is, deviation attributed to the absence of updating of the predictor model occurs between the actual value and the predicted value. Thus, it is preferable to update the parameters of the predictor model so as to allow dealing with the change in the operation conditions or the actual displacement of the main pump 10 as in the present embodiment. This can improve the accuracy of the predictive control.

The model predictive control section 31 computes a deviation between the displacement target value g_{ref} and the displacement predicted value qₚ\hat{ } computed on the basis of the predictor model, and computes the control input u(k) such that this deviation comes closer to 0 (zero). Specifically, the model predictive control section 31 computes an evaluation function J(k) represented by the following formula (6).

$$\begin{matrix}[ Formula 6 ] & \\ J ( k ) = {\sum }_{i = 1}^{{H}_{p}} {‖ {q}_{ref} ( k + i \vert k ) - {\hat{q}}_{p} ( k + i \vert k ) ‖}_{𝒬 ( i )}^{2} + {\sum }_{i = 0}^{{H}_{u} - 1} {‖ Δ \hat{u} ( k + i \vert k ) ‖}_{ℛ ( i )}^{2} & ( 6 )\end{matrix}$$

Δu\hat{ } is the prediction change amount of the control input. Hₚ represents a prediction horizon, and H_{d} represents a control horizon. The first term in the right side of formula (6) is the sum of squares of the deviation between the displacement target value g_{ref} and the displacement predicted value qₚ\hat{ } in the prediction horizon (i=1, . . . , Hₚ) with a predetermined time width. The second term in the right side of formula (6) is the sum of squares of the change amount of the control input in the control horizon (i=0, . . . , Hᵤ−1) with a predetermined time width. Q and R are design parameters of the control system used for weighting of each of the first term and the second term. (k+i|k) means a value according to each i in a step k. For example, in a case of i=2, (k+i|k) means a predicted value in a step subsequent by two steps to the step k (current time point) when prediction is executed in the step k. The displacement actual measured value qₚ is used as an initial value of the displacement predicted value qₚ\hat{ }. Moreover, for example, an initial value of the prediction change amount Δu\hat{ } corresponds to a value obtained by subtracting the control input u(k−1) in a step (k−1) previous to the step (k) from the control input u(k) in the step (k).

The model predictive control section 31 computes the control input u(k) such that the evaluation function J(k) including the displacement predicted value qₚ\hat{ } becomes the minimum under the control input constraints represented by the following formula (7).

$$\begin{matrix}[ Formula 7 ] & \\ {u}_{max} = \{ \begin{matrix}{u}_{max 1} , & e \geq {e}_{th} \\ {u}_{max 2} , & e < {e}_{th}\end{matrix} ( {u}_{max 1} > {u}_{max 2} ) & ( 7 )\end{matrix}$$

$${u}_{min} = \{ \begin{matrix}{u}_{min 1} , & e \geq {e}_{th} \\ {u}_{min 2} , & e < {e}_{th}\end{matrix} ( {u}_{min 1} < {u}_{min 2} )$$

The control input constraints refer to an upper limit value uₘₐₓ and a lower limit value uₘᵢₙ of the control input. In the present embodiment, the model predictive control section 31 computes the displacement deviation e as an evaluation value on the basis of the displacement target value g_{ref} and the displacement actual measured value qₚ, and changes the control input constraints depending on the computed displacement deviation e. A deviation threshold eₜₕ that is a threshold for the displacement deviation e is stored in the non-volatile memory of the pump controller 30. The model predictive control section 31 sets the values of the control input constraints depending on the magnitude relation between the displacement deviation e and the deviation threshold eₜₕ.

The upper limit value uₘₐₓ of the control input is a first upper limit value uₘₐₓ₁ when the displacement deviation e is equal to or larger than the deviation threshold eₜₕ, and is a second upper limit value uₘₐₓ₂ when the displacement deviation e is smaller than the deviation threshold eₜₕ. The first upper limit value uₘₐₓ₁ is only required to be a value in a range equal to or larger than the second current value I₂ and equal to or smaller than the maximum current value Iₘₐₓ. That is, the first upper limit value uₘₐₓ₁ is set in the range of the dead zone in which the output pressure of the solenoid proportional pressure reducing valve 11 is kept at the tank pressure Pt (constant value) even when the value of the electrical signal is changed. As the second upper limit value uₘₐₓ₂, a value that is larger than the first current value I₁ and is smaller than the second current value I₂ may be employed, or a value equal to or larger than the second current value I₂ may be employed. The second upper limit value uₘₐₓ₂ is only required to be a value smaller than the first upper limit value uₘₐₓ₁.

The lower limit value uₘᵢₙ of the control input is a first lower limit value uₘᵢₙ₁ when the displacement deviation e is equal to or larger than the deviation threshold eₜₕ, and is a second lower limit value uₘᵢₙ₂ when the displacement deviation e is smaller than the deviation threshold eₜₕ. The first lower limit value uₘᵢₙ₁ is only required to be a value in a range equal to or larger than the minimum current value Iₘᵢₙ and equal to or smaller than the first current value I₁. That is, the first lower limit value uₘᵢₙ₁ is set in the range of the dead zone in which the output pressure of the solenoid proportional pressure reducing valve 11 is kept at the pilot primary pressure Pp (constant value) even when the value of the electrical signal is changed. As the second lower limit value uₘᵢₙ₂, a value that is larger than the first current value I₁ and is smaller than the second current value I₂ may be employed, or a value equal to or smaller than the first current value I₁ may be employed. The second lower limit value uₘᵢₙ₂ is only required to be a value that is larger than the first lower limit value uₘᵢₙ₁ and is smaller than the second upper limit value uₘₐₓ₂. As the deviation threshold eₜₕ used as the condition for changing the control input constraints, values different between a case in which the upper limit value uₘₐₓ is changed and a case in which the lower limit value uₘᵢₙ is changed may be employed.

In the present embodiment, a change characteristic of the control input constraints with respect to the time has a characteristic obtained by discretizing a first-order system 1/(τs+1). s is the Laplace operator, and τ is a time constant. The time constant τ is set to any value.

### —Flow of Model Predictive Control—

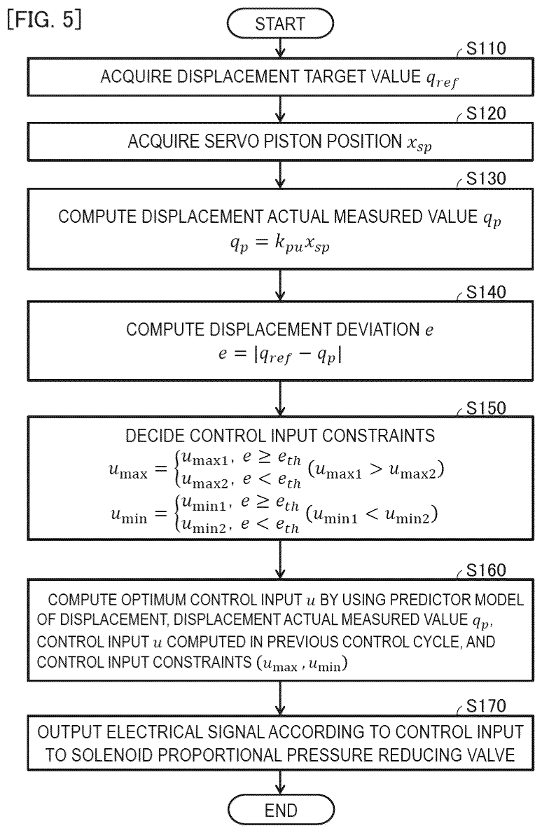

FIG. 5 is a flowchart of the model predictive control executed by the pump controller 30. For example, the control flow depicted in FIG. 5 is started in response to turning-on of an ignition switch of the work machine and is repeatedly executed at a predetermined control cycle.

In a step S110, the pump controller 30 acquires the displacement target value g_{ref} from the machine controller 40. In the next step S120, the pump controller 30 acquires the position xₓₚ of the servo piston 9b sensed by the position sensor 13. In the next step S130, the pump controller 30 computes the displacement actual measured value qₚ by multiplying the position xₓₚ of the servo piston 9b by the conversion coefficient kₚᵤ. In the next step S140, the pump controller 30 computes the displacement deviation e between the displacement target value g_{ref} and the displacement actual measured value qₚ.

In the next step S150, the pump controller 30 decides the control input constraints (formula (7)) depending on the magnitude of the displacement deviation e. In the next step S160, the pump controller 30 computes the optimum control input u such that the above-described evaluation function J (formula (6)) becomes the minimum on the basis of the predictor model (formulas (1) and (2)) of the displacement of the main pump 10, the displacement actual measured value qₚ computed in the step S130, the control input u computed in the previous control cycle, and the control input constraints (formula (7)) decided in the step S150. In the next step S170, the pump controller 30 outputs the electrical signal according to the control input u computed in the step S160 to the solenoid lid of the solenoid proportional pressure reducing valve 11.

Upon the end of the processing of the step S170, the processing depicted in the flowchart depicted in FIG. 5 in this control cycle is ended. In the next control cycle, the pump controller 30 executes the processing from the step S110 to the step S170 again.

### —Time-series Change in Control Input Constraints—

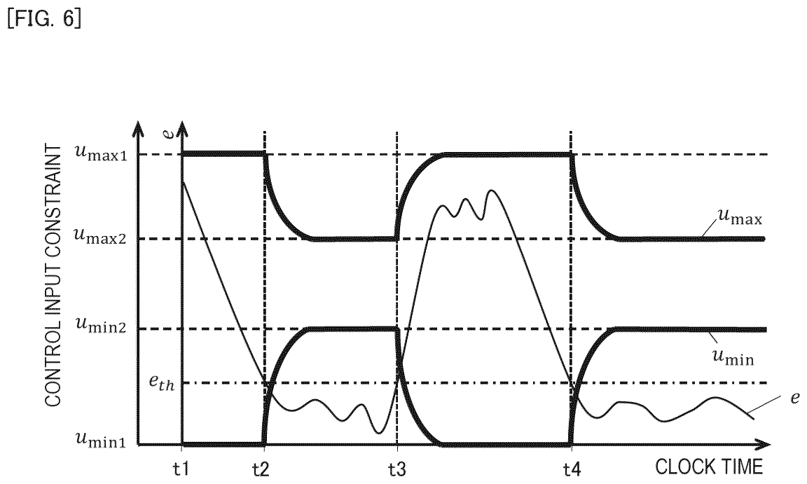

FIG. 6 is a time-series waveform diagram of the control input constraints (upper limit value uₘₐₓ and lower limit value uₘᵢₙ) set by the pump controller 30. In FIG. 6, the upper limit value uₘₐₓ and the lower limit value uₘᵢₙ of the control input are indicated by thick solid lines, and the displacement deviation e is indicated by a thin solid line. When the displacement target value g_{ref} is changed, the displacement actual measured value qₚ varies to track the displacement target value g_{ref}. This makes the displacement deviation e small. From a clock time t1 to a clock time t2, the displacement deviation e is equal to or larger than the deviation threshold eₜₕ. Thus, the upper limit value uₘₐₓ of the control input becomes the first upper limit value uₘₐₓ₁, and the lower limit value uₘᵢₙ of the control input becomes the first lower limit value uₘᵢₙ₁. From the clock time t2 to a clock time t3, the displacement deviation e is smaller than the deviation threshold eₜₕ. Thus, the upper limit value uₘₐₓof the control input becomes the second upper limit value uₘₐₓ₂ after the elapse of a predetermined time from the clock time t2, and the lower limit value uₘᵢₙ of the control input becomes the second lower limit value uₘᵢₙ₂ after the elapse of the predetermined time from the clock time t2.

Thereafter, the displacement deviation e increases, and is equal to or larger than the deviation threshold eₜₕ from the clock time t3 to a clock time t4. Thus, the upper limit value uₘₐₓ of the control input becomes the first upper limit value uₘₐₓ₁ after the elapse of a predetermined time from the clock time t3, and the lower limit value uₘᵢₙ of the control input becomes the first lower limit value uₘᵢₙ₁ after the elapse of the predetermined time from the clock time t3. Thereafter, the displacement deviation e decreases again, and is smaller than the deviation threshold eₜₕ after the clock time t4. Thus, the upper limit value uₘₐₓ of the control input becomes the second upper limit value uₘₐₓ₂ after the elapse of a predetermined time from the clock time t4, and the lower limit value uₘᵢₙ of the control input becomes the second lower limit value uₘᵢₙ₂ after the elapse of the predetermined time from the clock time t4. Note that the control input constraints are prevented from immediately changing by delay processing based on the first-order system.

### Simulation Result of Present Embodiment and Comparative Example Thereof

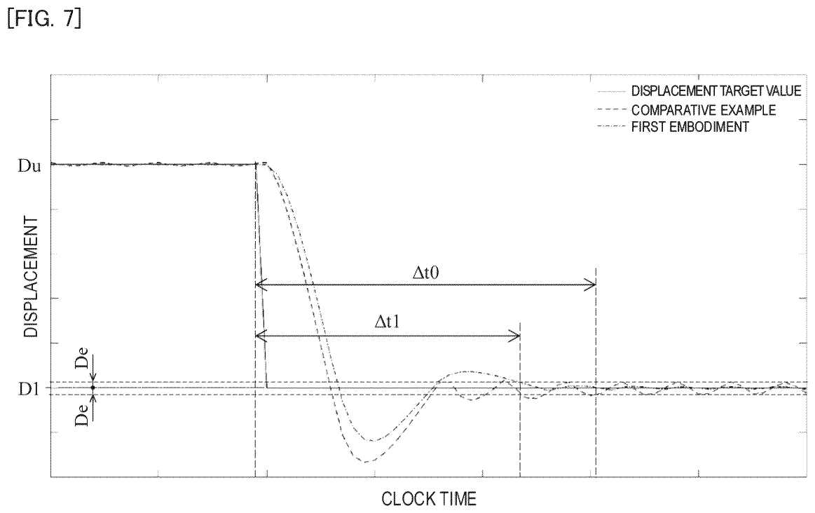

With reference to FIG. 7, main behavior and operation and effects of the pump system 100 according to the present embodiment are described. FIG. 7 is a diagram depicting a time-series change in the displacement in the pump system 100. In FIG. 7, the displacement target value g_{ref} is indicated by a solid line. A time-series change in the displacement in the present embodiment is indicated by a one-dot-chain line. Further, in order to clarify the operation and effects of the present embodiment, a time-series change in the displacement controlled by the pump controller according to the comparative example of the present embodiment is indicated by a dashed line. The control of the pump controller according to the comparative example is different from the control in the present embodiment only in that the control input constraints are not changed. That is, in the comparative example, the upper limit value uₘₐₓ of the control input is always the first upper limit value uₘₐₓ₁, and the lower limit value uₘᵢₙ of the control input is always the first lower limit value uₘᵢₙ₁. A horizontal axis indicates the clock time (elapsed time), and a vertical axis indicates the displacement of the main pump 10. The curves indicating the time-series change in the displacement according to the present embodiment and the comparative example are obtained by a numerical simulation.

In FIG. 7, settling times Δt0 and Δt1 until the displacement of the main pump 10 is stabilized are indicated. The settling times Δt0 and Δt1 are times from a clock time at which the displacement target value g_{ref} has changed to a settling clock time. In a case in which the displacement deviation e remains in a predetermined error range (displacement target value g_{ref}±De), the settling clock time is defined as a clock time at which the displacement deviation e has entered the error range (displacement target value g_{ref}±De).

As depicted in FIG. 7, when the displacement target value g_{ref} has decreased from a predetermined amount Du to a predetermined amount D1, an undershoot in which the displacement becomes smaller than the displacement target value g_{ref} (=D1) occurs in each of the present embodiment and the comparative example. In the comparative example, the undershoot amount is large as compared with the present embodiment. Moreover, in the comparative example, hunting (oscillation) of the displacement is continued from the occurrence of the undershoot. In other words, in the comparative example, oscillation with high amplitude continues long.

In contrast, in the present embodiment, the undershoot amount is small as compared with the comparative example. Further, in the present embodiment, the hunting (oscillation) of the displacement from the occurrence of the undershoot is prevented. As a result, the settling time Δt1 in the present embodiment is short compared with the settling time Δt0 in the comparative example.

As described above, the present embodiment uses the model predictive control (MPC) that can take in the constraints on the control input as the condition at of control input computation step for non-linearity due to the upper and lower limits of the value of the electrical signal to the solenoid proportional pressure reducing valve 11. Moreover, in the present embodiment, the control input constraints are made variable for the non-linearity based on the change in the control pressure characteristic of the pressure receiving chamber 9d of the tilting actuator 9 when the displacement actual measured value qₚ is close to the displacement target value g_{ref}. Due to this, the magnitude of the undershoot (undershoot amount) that occurs when the actual displacement is caused to track the displacement target value g_{ref} can be made small, and the occurrence of the hunting (oscillation) can be prevented. As a result, the settling time at the transient response can be shortened. That is, according to the present embodiment, the tracking performance of the actual displacement with respect to the displacement target value g_{ref} of the main pump 10 can be improved. As a result, delay of operation of the hydraulic actuator 17 mounted in the work machine such as a hydraulic excavator can be suppressed. The suppression of the delay of operation of the hydraulic actuator 17 leads to improvement in work performance by the work machine.

### Operation and Effects of Present Embodiment

According to the above-described embodiment, the following operation and effects are provided.

(1) The pump system (control system of the work machine) 100 includes the main pump (hydraulic pump) 10, the displacement control unit 20, the position sensor 13, and the pump controller (controller) 30. The main pump 10 is rotationally driven by the engine (prime mover) 19, and supplies the hydraulic operating oil to the hydraulic actuator 17. The displacement control unit 20 controls the displacement of the main pump 10 according to the control input u. The position sensor 13 functions as the displacement sensor that senses the displacement actual measured value qₚ of the main pump 10. The pump controller 30 acquires the displacement target value g_{ref} of the main pump 10, and outputs the control input u according to the displacement target value g_{ref} to the displacement control unit 20. The predictor model that is the mathematical model for predicting the displacement of the main pump 10 is stored in the pump controller 30. The pump controller 30 computes the displacement predicted value qₚ\hat{ } of the main pump 10 by using the predictor model. The pump controller 30 computes the optimum control input u on the basis of the displacement predicted value qₚ\hat{ } and the constraints (upper limit value uₘₐₓ and lower limit value uₘᵢₙ) on the control input u. The pump controller 30 computes the evaluation value (in the present embodiment, displacement deviation e) on the basis of the displacement target value g_{ref} and the displacement actual measured value qₚ. The pump controller 30 changes the constraints on the control input u depending on the evaluation value.

According to this configuration, the tracking performance of the displacement actual measured value qₚ with respect to the displacement target value g_{ref} of the main pump 10 can be improved. That is, the responsiveness of the displacement control for the main pump 10 can be improved. Due to this, the accuracy of control of the hydraulic actuator 17 can be improved, and thus improvement in work performance by the work machine can be achieved.

(2) In the pump controller 30, the threshold (deviation threshold eₜₕ) for the evaluation value (displacement deviation e) is stored. The pump controller 30 sets the values of the constraints on the control input depending on the magnitude relation between the evaluation value (displacement deviation e) and the threshold (deviation threshold eₜₕ). The pump controller 30 employs a first-order system for the change characteristic of the constraints on the control input with respect to the time. According to this configuration, the undershoot amount (or overshoot amount) and the oscillation amplitude can be made small as compared with a case of discontinuously changing the constraints on the control input.

(3) The constraints on the control input include the upper limit value uₘₐₓ and the lower limit value uₘᵢₙ of the control input. The pump controller 30 sets the upper limit value uₘₐₓ to the first upper limit value uₘₐₓ₁ when the evaluation value (displacement deviation e) is equal to or larger than the threshold eₜₕ for the upper limit value. The pump controller 30 sets the upper limit value uₘₐₓ to the second upper limit value uₘₐₓ₂ smaller than the first upper limit value uₘₐₓ₁ when the evaluation value (displacement deviation e) is smaller than the threshold eₜₕ for the upper limit value. Further, the pump controller 30 sets the lower limit value uₘᵢₙ to the first lower limit value uₘᵢₙ₁ when the evaluation value (displacement deviation e) is equal to or larger than the threshold eₜₕ for the lower limit value. The pump controller 30 sets the lower limit value uₘᵢₙ to the second lower limit value uₘᵢₙ₂ larger than the first lower limit value uₘᵢₙ₁ when the evaluation value (displacement deviation e) is smaller than the threshold eₜₕ for the lower limit value. Although the example in which the threshold for the upper limit value and the threshold for the lower limit value are the same value eₜₕ has been described in the present embodiment, different values may be employed as the threshold for the upper limit value and the threshold for the lower limit value.

According to this configuration, when the evaluation value (displacement deviation e) becomes small, both the upper limit value uₘₐₓ and the lower limit value uₘᵢₙ of the control input come closer to the steady-state value (target value). Due to this, the undershoot amount can be made small and the oscillation amplitude can be suppressed as compared with a case of changing only the upper limit value uₘₐₓ or a case of changing only the lower limit value uₘᵢₙ. That is, the settling time can be effectively shortened.

(4) The pump controller 30 uses, as the evaluation value, the displacement deviation e that is the deviation between the displacement target value g_{ref} and the displacement actual measured value qₚ. According to this configuration, the control input constraints can be properly changed in response to change in the displacement deviation e.

As the evaluation value used for changing the control input constraints, the value of the evaluation function J(k) minimized in order to decide the control input u(k) may be used instead of the displacement deviation e. The evaluation function J(k) includes the sum of squares of the deviation between the displacement target value and the displacement predicted value in the prediction horizon with a predetermined time width. Thus, also when the constraints on the control input are changed depending on the value of the evaluation function J(k), the control input constraints can be properly changed. As above, either the displacement deviation e or the value of the evaluation function may be used as the evaluation value. Thus, in the present embodiment, the flexibility in the configuration of the control system is high.

(5) The pump controller 30 updates the predictor model (mathematical model) by using the displacement actual measured value qₚ and the control input u. In the present embodiment, in a case in which a characteristic of the predictor model greatly changes, the optimum parameter predicted values are computed to match the characteristic resulting from the change, and the predictor model for prediction is updated on the basis of the parameter predicted values. Due to this, the pump displacement predicted value can be more accurately computed by using the predictor model that matches the actual characteristic. As above, in the present embodiment, by making the constraints on the control input u variable and updating the predictor model, the response time of the displacement control for the main pump 10 can be reduced as compared with a case in which the predictor model is not updated. As a result, the work efficiency of the work machine can be improved.

### Second Embodiment

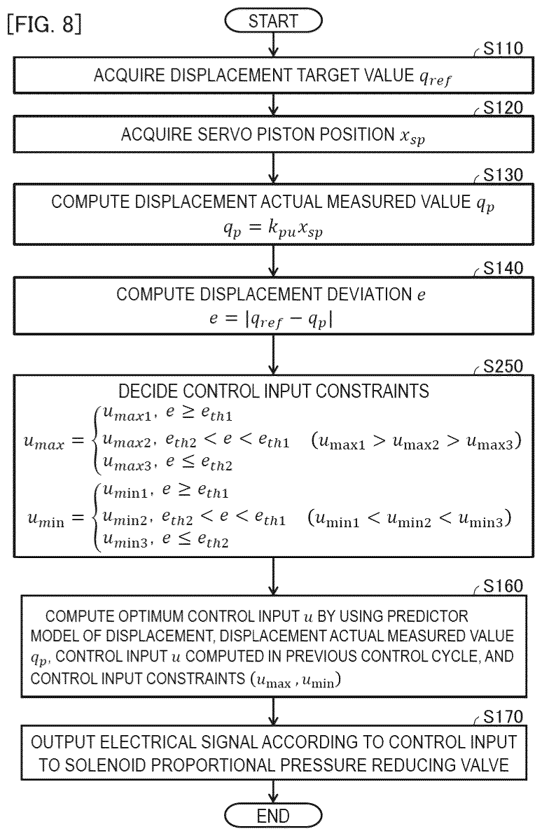

The pump system 100 according to a second embodiment of the present invention is described with reference to FIGS. 8 to 10. A configuration that is the same as or corresponds to the configuration described in the first embodiment is given the same reference numeral, and differences are mainly described. In the first embodiment, the description has been given of the example in which only one deviation threshold used for changing the control input constraints is stored in the pump controller 30. In contrast, in this second embodiment, a plurality of deviation thresholds used for changing the control input constraints are stored in the pump controller 30. That is, in the second embodiment, the control input constraints change at a plurality of stages. A detailed description is given below.

FIG. 8 is a diagram similar to FIG. 5, and is a flowchart of model predictive control executed by the pump controller 30 according to the second embodiment. In the flowchart of FIG. 8, processing of a step S250 is executed instead of the processing of the step S150 in the flowchart of FIG. 5. The processing of the steps S110 to S140, S160, and S170 is the same as that in the first embodiment, and thus description thereof is omitted.

As depicted in FIG. 8, in the step S250, the pump controller 30 decides the control input constraints depending on the magnitude of the displacement deviation e.

In this second embodiment, the control input constraints are represented by the following formula (8).

$$\begin{matrix}[ Formula 8 ] & \\ {u}_{max} = \{ \begin{matrix}{u}_{max 1} , & e \geq {e}_{th 1} \\ {u}_{max 2} , & {e}_{th 2} < e < {e}_{th 1} \\ {u}_{max 3} , & e \leq {e}_{th 2}\end{matrix} ( {u}_{max 1} > {u}_{max 2} > {u}_{max 3} ) & ( 8 )\end{matrix}$$

$${u}_{min} = \{ \begin{matrix}{u}_{min 1} , & e \geq {e}_{th 1} \\ {u}_{min 2} , & {e}_{th 2} < e < {e}_{th 1} \\ {u}_{min 3} , & e \leq {e}_{th 2}\end{matrix} ( {u}_{min 1} < {u}_{min 2} < {u}_{min 3} )$$

The upper limit value uₘₐₓ of the control input is the first upper limit value uₘₐₓ₁ when the displacement deviation e is equal to or larger than a first deviation threshold eₜₕ₁, and is the second upper limit value uₘₐₓ₂ when the displacement deviation e is smaller than the first deviation threshold eₜn, and is larger than a second deviation threshold eₜₕ₂. The first upper limit value uₘₐₓ₁ is only required to be a value in a range equal to or larger than the second current value I₂ and equal to or smaller than the maximum current value Iₘₐₓ. That is, the first upper limit value uₘₐₓ₁ is set in the range of the dead zone in which the output pressure of the solenoid proportional pressure reducing valve 11 is kept at the tank pressure Pt (constant value) even when the value of the electrical signal is changed. The second upper limit value uₘₐₓ₂ is a value smaller than the first upper limit value uₘₐₓ₁. Further, the upper limit value uₘₐₓ of the control input is a third upper limit value uₘₐₓ₃ when the displacement deviation e is equal to or smaller than the second deviation threshold eₜₕ₂. The third upper limit value uₘₐₓ₃ is a value smaller than the second upper limit value uₘₐₓ₂.

The lower limit value uₘᵢₙ of the control input is the first lower limit value uₘᵢₙ₁ when the displacement deviation e is equal to or larger than the first deviation threshold eₜₕ₁, and is the second lower limit value uₘᵢₙ₂ when the displacement deviation e is smaller than the first deviation threshold eₜₕ₁ and is larger than the second deviation threshold eₜₕ₂. The first lower limit value uₘᵢₙ₁ is only required to be a value in a range equal to or larger than the minimum current value Iₘᵢₙ and equal to or smaller than the first current value I₁. That is, the first lower limit value uₘᵢₙ₁ is set in the range of the dead zone in which the output pressure of the solenoid proportional pressure reducing valve 11 is kept at the pilot primary pressure Pp (constant value) even when the value of the electrical signal is changed. The second lower limit value uₘᵢₙ₂ is a value larger than the first lower limit value uₘᵢₙ₁. Further, the lower limit value uₘᵢₙ of the control input is a third lower limit value uₘᵢₙ₃ when the displacement deviation e is equal to or smaller than the second deviation threshold eₜₕ₂. The third lower limit value uₘᵢₙ₃ is a value larger than the second lower limit value uₘᵢₙ₂.

As above, the two deviation thresholds eₜₕ₁ and eₜₕ₂ used for changing the upper limit value uₘₐₓ are stored in the pump controller 30 of this second embodiment. The upper limit value uₘₐₓ is set to any one of three values of the first upper limit value uₘₐₓ₁, the second upper limit value uₘₐₓ₂, and the third upper limit value uₘₐₓ₃ depending on the magnitude of the displacement deviation e. Similarly, the two deviation thresholds eₜₕ₁ and eₜₕ₂ used for changing the lower limit value uₘᵢₙ are stored in the pump controller 30 of this second embodiment. The lower limit value uₘᵢₙ is set to any one of three values of the first lower limit value uₘᵢₙ₁, the second lower limit value uₘᵢₙ₂, and the third lower limit value uₘᵢₙ₃ depending on the magnitude of the displacement deviation e.

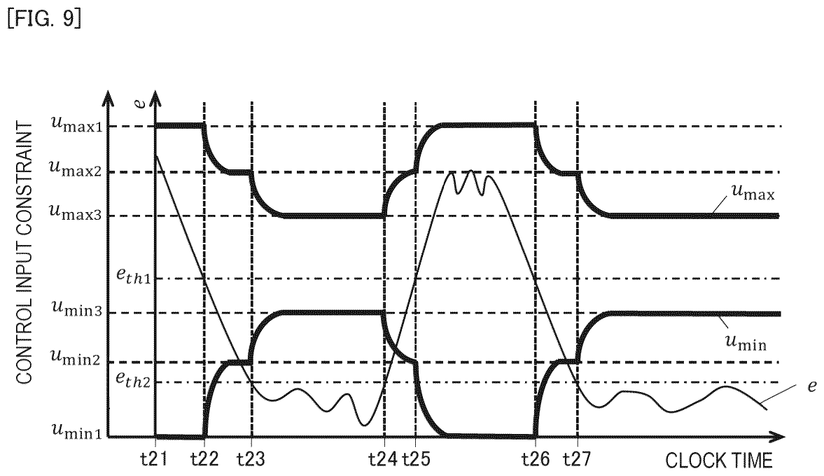

FIG. 9 is a diagram similar to FIG. 6, and is a time-series waveform diagram of the control input constraints (upper limit value uₘₐₓ and lower limit value uₘᵢₙ) set by the pump controller 30 according to the second embodiment. When the displacement target value g_{ref} is changed, the displacement actual measured value qₚ varies to track the displacement target value g_{ref}. This makes the displacement deviation e smaller. From a clock time t21 to a clock time t22, the displacement deviation e is equal to or larger than the first deviation threshold eₜₕ₁. Thus, the upper limit value uₘₐₓ of the control input becomes the first upper limit value uₘₐₓ₁, and the lower limit value uₘᵢₙ of the control input becomes the first lower limit value uₘᵢₙ₁. From the clock time t22 to a clock time t23, the displacement deviation e is smaller than the first deviation threshold eₜₕ₁ and is larger than the second deviation threshold eₜₕ₂. Thus, the upper limit value uₘₐₓ of the control input becomes the second upper limit value uₘₐₓ₂ after the elapse of a predetermined time from the clock time t22, and the lower limit value uₘᵢₙ of the control input becomes the second lower limit value uₘᵢₙ₂ after the elapse of the predetermined time from the clock time t22. From the clock time t23 to a clock time t24, the displacement deviation e is equal to or smaller than the second deviation threshold eₜₕ₂. Thus, the upper limit value uₘₐₓ of the control input becomes the third upper limit value uₘₐₓ₃ after the elapse of a predetermined time from the clock time t23, and the lower limit value uₘᵢₙ of the control input becomes the third lower limit value uₘᵢₙ₃ after the elapse of the predetermined time from the clock time t23.

Thereafter, the displacement deviation e increases. From the clock time t24 to a clock time t25, the displacement deviation e is a value that is larger than the second deviation threshold eₜₕ₂ and is smaller than the first deviation threshold eₜₕ₁. Thus, the upper limit value uₘₐₓ of the control input becomes the second upper limit value uₘₐₓ₂ after the elapse of a predetermined time from the clock time t24, and the lower limit value uₘᵢₙ of the control input becomes the second lower limit value uₘᵢₙ₂ after the elapse of the predetermined time from the clock time t24. From the clock time t25 to a clock time t26, the displacement deviation e is equal to or larger than the first deviation threshold eₜₕ₁. Thus, the upper limit value uₘₐₓ of the control input becomes the first upper limit value uₘₐₓ₁ after the elapse of a predetermined time from the clock time t25, and the lower limit value uₘᵢₙ of the control input becomes the first lower limit value uₘᵢₙ₁ after the elapse of the predetermined time from the clock time t25.

Thereafter, the displacement deviation e decreases again. From the clock time t26 to a clock time t27, the displacement deviation e is smaller than the first deviation threshold eₜₕ₁ and is larger than the second deviation threshold eₜₕ₂. Thus, the upper limit value uₘₐₓ of the control input becomes the second upper limit value uₘₐₓ₂ after the elapse of a predetermined time from the clock time t26, and the lower limit value uₘᵢₙ of the control input becomes the second lower limit value uₘᵢₙ₂ after the elapse of the predetermined time from the clock time t26. After the clock time t27, the displacement deviation e is equal to or smaller than the second deviation threshold eₜₕ₂. Thus, the upper limit value uₘₐₓ of the control input becomes the third upper limit value uₘₐₓ₃ after the elapse of a predetermined time from the clock time t27, and the lower limit value uₘᵢₙ of the control input becomes the third lower limit value uₘᵢₙ₃ after the elapse of the predetermined time from the clock time t27.

As the first deviation threshold eₜₕ₁ and the second deviation threshold eₜₕ₂ used as the condition for changing the control input constraints, values different between a case in which the upper limit value uₘₐₓ is changed and a case in which the lower limit value uₘᵢₙ is changed may be employed.

Moreover, in this second embodiment, the control input constraints are prevented from immediately changing by delay processing based on the first-order similarly to the first embodiment. The same value may be employed or different values may be employed as a time constant Ta used for first-order processing executed when the displacement deviation e overpasses the first deviation threshold eₜₕ₁ (clock times t22, t25, and t26) and a time constant Tb used for first-order processing executed when the displacement deviation e overpasses the second deviation threshold eₜₕ₂ (clock times t23, t24, and t27).

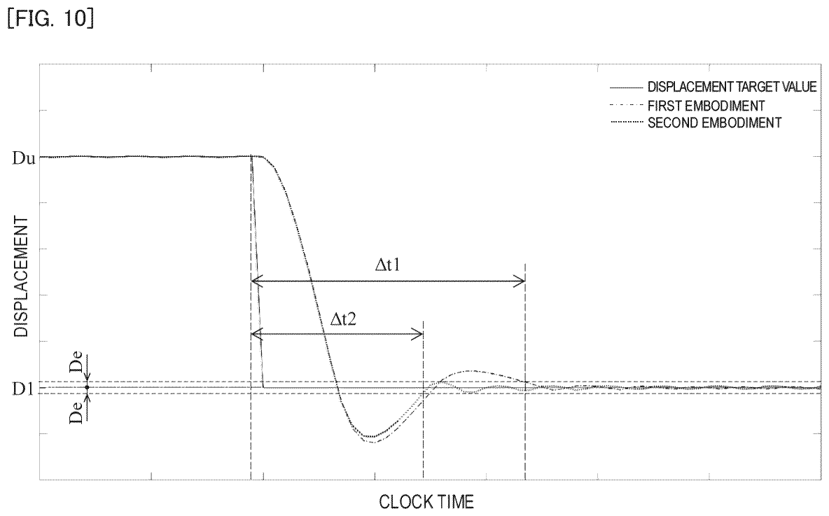

FIG. 10 is a diagram similar to FIG. 7, and is a diagram depicting a time-series change in the displacement in the pump system 100 according to the second embodiment. In FIG. 10, a time-series change in the displacement in this second embodiment is indicated by a dotted line. Further, in order to clarify operation and effects of this second embodiment, a time-series change in the displacement in the first embodiment is indicated by a one-dot-chain line.

In this second embodiment, the undershoot amount is small as compared with the first embodiment. Moreover, the amplitude of the oscillation after the occurrence of the undershoot is also lower. As a result, the settling time Δt2 in this second embodiment is shorter than the settling time Δt1 in the first embodiment.

As above, in this second embodiment, a plurality of thresholds (deviation thresholds eₜₕ₁ and eₜₕ₂) for the evaluation value (displacement deviation e) are stored in the pump controller 30. According to this configuration, the responsiveness of the displacement control for the main pump 10 can be further improved. Therefore, further improvement in work performance can be achieved according to this second embodiment. Similarly to the first embodiment, the accuracy of the predictive control can be further improved by updating the predictor model by a recursive least squares method also in the second embodiment.

### Modification of Second Embodiment

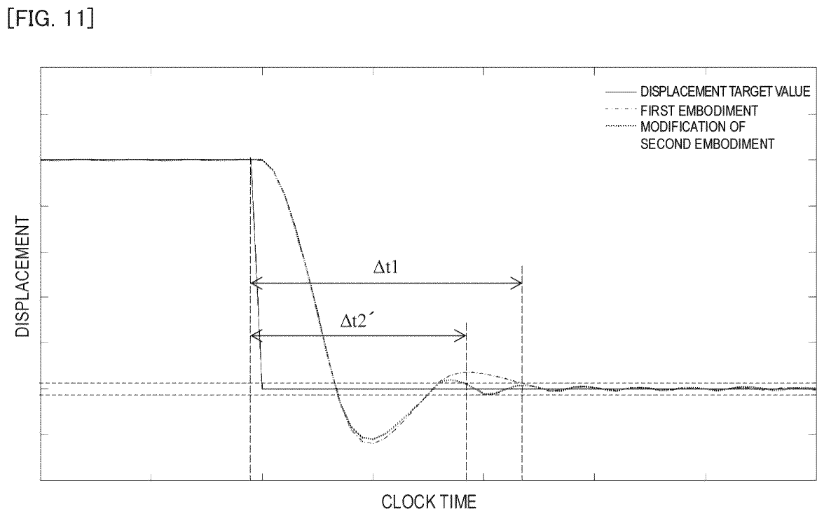

In the second embodiment, the magnitude relation between the second upper limit value uₘₐₓ₂ and the third upper limit value uₘₐₓ₃ may be reversed, and the magnitude relation between the second lower limit value uₘᵢₙ₂ and the third lower limit value uₘᵢₙ₃ may be reversed (uₘₐₓ₂<uₘₐₓ₃, uₘᵢₙ₃<uₘᵢₙ₂). FIG. 11 is a diagram similar to FIG. 10, and is a diagram depicting a time-series change in the displacement in the pump system 100 according to a modification of the second embodiment. In FIG. 11, a time-series change in the displacement in the modification of this second embodiment is indicated by a dotted line. Further, in order to clarify operation and effects of the modification of this second embodiment, a time-series change in the displacement in the first embodiment is indicated by a one-dot-chain line.

In the modification of this second embodiment, the undershoot amount is small as compared with the first embodiment. Moreover, the amplitude of the oscillation after the occurrence of the undershoot is also lower. As a result, a settling time Δt2′ in the modification of this second embodiment is shorter than the settling time Δt1 in the first embodiment.

As above, according to the modification of this second embodiment, the responsiveness of the displacement control for the main pump 10 can be further improved similarly to the second embodiment.

### Another Modification of Second Embodiment

The pump controller 30 according to the second embodiment changes the control input constraints by using the two deviation thresholds eₜₕ₁ and eₜₕ₂. In contrast, the pump controller 30 may change the control input constraints by using three or more deviation thresholds. In this case, three or more values can be used also as the time constants T in the first-order processing.

### Third Embodiment

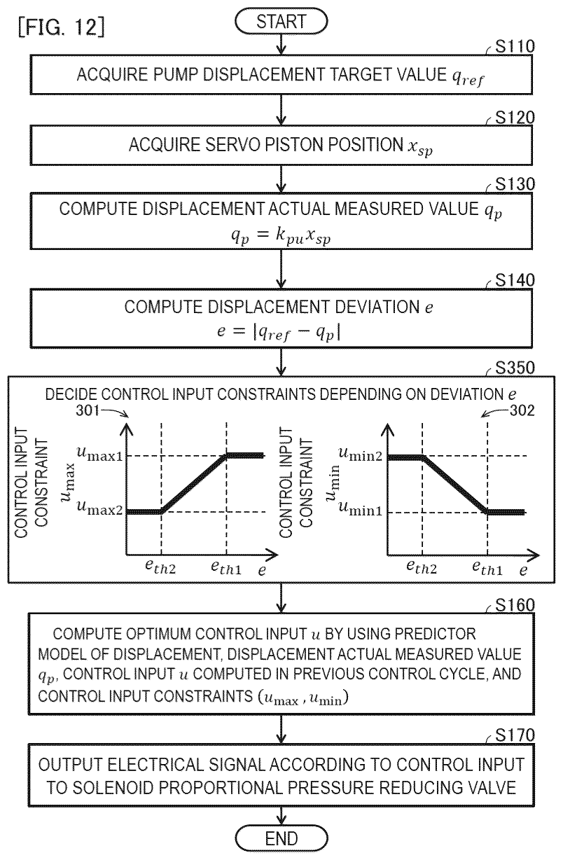

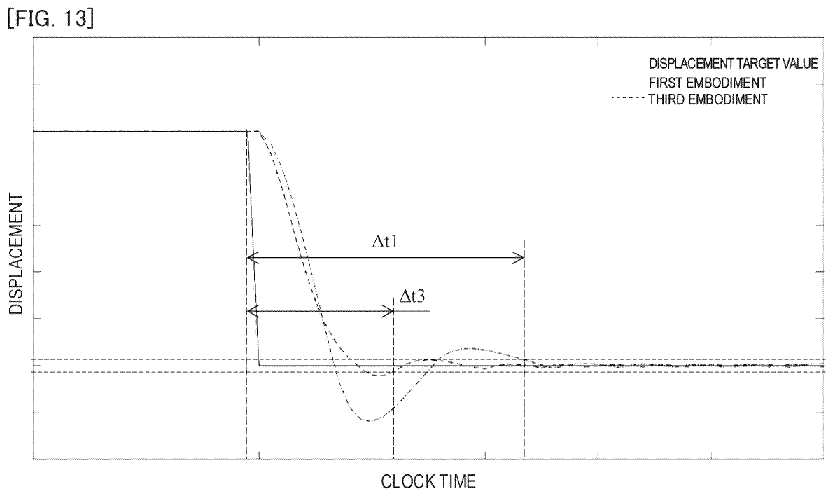

The pump system 100 according to a third embodiment of the present invention is described with reference to FIGS. 12 and 13. A configuration that is the same as or corresponds to the configuration described in the first embodiment is given the same reference numeral, and differences are mainly described. In the first embodiment, the description has been given of the example in which the first-order system is employed for the change characteristic of the control input constraints with respect to the time. In contrast, the delay processing when the control input constraints are changed is not executed in this third embodiment. The control input constraints are continuously changed in response to change in the deviation threshold by using a constraint characteristic table instead of the delay processing.

FIG. 12 is a diagram similar to FIG. 5, and is a flowchart of model predictive control executed by the pump controller 30 according to the third embodiment. In the flowchart of FIG. 12, processing of a step S350 is executed instead of the processing of the step S150 in the flowchart of FIG. 5. The processing of the steps S110 to S140, S160, and S170 is the same as that in the first embodiment, and thus description thereof is omitted.

As depicted in FIG. 12, in the step S350, the pump controller 30 decides the control input constraints depending on the magnitude of the displacement deviation e. In this third embodiment, in decision of the control input constraints, constraint tables 301 and 302 that define a relation between the displacement deviation e and the control input constraint are used.

The constraint tables 301 and 302 are stored in the non-volatile memory of the pump controller 30. The constraint tables 301 and 302 include the constraint table 301 for the upper limit value (hereinafter, referred to also as upper limit value table 301) that defines a characteristic of the upper limit value uₘₐₓ that continuously changes with respect to the displacement deviation e and the constraint table 302 for the lower limit value (hereinafter, referred to also as lower limit value table 302) that defines a characteristic of the lower limit value uₘᵢₙ that continuously changes with respect to the displacement deviation e.

The relation between the displacement deviation e and the upper limit value uₘₐₓ defined in the upper limit value table 301 is as follows. When the displacement deviation e is equal to or larger than the first deviation threshold eₜₕ₁, the upper limit value uₘₐₓ is the first upper limit value uₘₐₓ₁. When the displacement deviation e is equal to or smaller than the second deviation threshold eₜₕ₂, the upper limit value uₘₐₓ is the second upper limit value uₘₐₓ₂. In a range of the displacement deviation e from the first deviation threshold eₜₕ₁ to the second deviation threshold eₜₕ₂, the upper limit value uₘₐₓ becomes smaller as the displacement deviation e becomes smaller.

The relation between the displacement deviation e and the lower limit value uₘᵢₙ defined in the lower limit value table 302 is as follows. When the displacement deviation e is equal to or larger than the first deviation threshold eₜₕ₁, the lower limit value uₘᵢₙ is the first lower limit value uₘᵢₙ₁. When the displacement deviation e is equal to or smaller than the second deviation threshold eₜₕ₂, the lower limit value uₘᵢₙ is the second lower limit value uₘᵢₙ₂. In the range of the displacement deviation e from the first deviation threshold eₜₕ₁ to the second deviation threshold eₜₕ₂, the lower limit value uₘᵢₙ becomes larger as the displacement deviation e becomes smaller.

FIG. 12 depicts the example in which the constraint tables 301 and 302 store the characteristic in which the control input constraint linearly changes in response to the change in the displacement deviation e. However, the characteristic stored in the constraint table is not limited to the linear characteristic, and may be a non-linear characteristic based on a quadratic curve, a cubic curve, or the like.

In the step S350, the pump controller 30 refers to the upper limit value table 301, and sets the upper limit value uₘₐₓ on the basis of the displacement deviation e. Further, the pump controller 30 refers to the lower limit value table 302, and sets the lower limit value uₘᵢₙ on the basis of the displacement deviation e.

FIG. 13 is a diagram similar to FIG. 7, and is a diagram depicting a time-series change in the displacement in the pump system 100 according to the third embodiment. In FIG. 13, a time-series change in the displacement in this third embodiment is indicated by a dashed line. Further, in order to clarify operation and effects of this third embodiment, a time-series change in the displacement in the first embodiment is indicated by a one-dot-chain line.

In this third embodiment, the undershoot amount is small as compared with the first embodiment and the second embodiment. Moreover, the amplitude of the oscillation after the occurrence of the undershoot is also lower. As a result, a settling time Δt3 in this third embodiment is shorter than the settling time Δt1 in the first embodiment and the settling time Δt2 in the second embodiment.

As above, in this third embodiment, the constraint tables 301 and 302 that define the characteristic of the constraint on the control input that continuously changes with respect to the evaluation value (displacement deviation e) are stored in the pump controller 30. The pump controller 30 refers to the constraint tables 301 and 302, and sets the values of the constraints (upper limit value uₘₐₓ and lower limit value uₘᵢₙ) on the control input on the basis of the evaluation value (displacement deviation e). According to this configuration, the responsiveness of the displacement control for the main pump 10 can be further improved. Therefore, further improvement in work performance can be achieved according to this third embodiment. Similarly to the first embodiment, the accuracy of the predictive control can be further improved by updating the predictor model by a recursive least squares method also in the third embodiment.

The following modifications are also within the scope of the present invention, and it is also possible to combine a configuration depicted in the modification and a configuration explained in the above-described embodiment and combine configurations explained in the above-described different embodiments with each other and combine configurations to be explained in the following different modifications with each other.

### <Modification 1>

In the above-described embodiments, the description has been given of the example in which the control input u is the control current (excitation current) supplied to the solenoid lid of the solenoid proportional pressure reducing valve 11. However, a voltage to control the excitation current supplied to the solenoid lid of the solenoid proportional pressure reducing valve 11 may be employed as the control input u.

### <Modification 2>

In the above-described embodiments, the description has been given of the example in which the pilot pump 18 is disposed as the pilot hydraulic fluid source for supply to the solenoid proportional pressure reducing valve 11. However, the delivery pressure of the main pump 10 may be reduced by a pressure reducing valve and the resulting pressure may be supplied to the solenoid proportional pressure reducing valve 11. That is, the control pressure to control the displacement of the main pump 10 may be generated by the pressure of the hydraulic operating oil delivered from the main pump 10 itself.

### <Modification 3>

In the above-described embodiments, the description has been given of the example in which the pump controller 30 changes both the upper limit value uₘₐₓ and the lower limit value uₘᵢₙ of the control input depending on the evaluation value. However, the present invention is not limited thereto. The pump controller 30 may change only one of the upper limit value uₘₐₓ and the lower limit value uₘᵢₙ of the control input depending on the evaluation value. That is, the pump controller 30 is only required to be configured to change at least one of the upper limit value uₘₐₓ and the lower limit value uₘᵢₙ of the control input depending on the evaluation value.

### <Modification 4>

In the above-described embodiments, the description has been given of the example in which the control valve 16 is disposed between the main pump 10 and the hydraulic actuator 17. However, the present invention may be applied to a hydraulic system in which the main pump 10 and the hydraulic actuator 17 are connected to each other in a closed circuit without disposing the control valve 16. In this configuration, the responsiveness of the displacement control for the main pump 10 becomes more important. Thus, effects of the present invention develop more significantly.

### <Modification 5>

In the above-described embodiments, the example in which the work machine is the hydraulic excavator has been described. However, the work machine is not limited to the hydraulic excavator, and may be a wheel loader, a road machine, or the like.

Although the embodiments of the present invention have been described above, the above-described embodiments have merely depicted part of application examples of the present invention, and do not intend to limit the technological scope of the present invention to the specific configurations of the above-described embodiments.

### DESCRIPTION OF REFERENCE CHARACTERS

9: Tilting actuator
9a: Cylinder chamber
9b: Servo piston
9c: Pressure receiving chamber
9d: Pressure receiving chamber (control pressure chamber)
10: Main pump (hydraulic pump of the variable displacement type)
11: Solenoid proportional pressure reducing valve
13: Position sensor (displacement sensor)
17: Hydraulic actuator
18: Pilot pump (pilot hydraulic fluid source)
19: Engine (prime mover)
20: Displacement control unit
30: Pump controller (controller)
31: Model predictive control section
32: Predictor
33: Recursive least squares solver
39: Control target (plant)
40: Machine controller
100: Pump system
301: Upper limit value table (constraint table)
302: Lower limit value table (constraint table)
A: System matrix
B: Control input vector
C: Output vector
e: Displacement deviation (deviation between a displacement target value and a displacement actual measured value)
eₜₕ: Deviation threshold (threshold for an evaluation value, threshold for a lower limit value, threshold for an upper limit value)
eₜₕ₁: First deviation threshold (threshold for the evaluation value)
eₜₕ₂: Second deviation threshold (threshold for the evaluation value)
qₚ: Displacement actual measured value
qₚ\hat{ }: Displacement predicted value
g_{ref}: Displacement target value
u: Control input
uₘₐₓ: Upper limit value of the control input (value of a constraint on the control input)
uₘₐₓ₁: First upper limit value
uₘₐₓ₂: Second upper limit value
uₘₐₓ₃: Third upper limit value
uₘᵢₙ: Lower limit value of the control input (value of a constraint on the control input)
uₘᵢₙ₁: First lower limit value
uₘᵢₙ₂: Second lower limit value
uₘᵢₙ₃: Third lower limit value
x: State vector
Δt0 to Δt3: Settling time
c: Predictive error
0: Parameter predicted value

1. A control system of a work machine, the control system comprising:
a hydraulic pump that is rotationally driven by a prime mover and supplies hydraulic operating oil to a hydraulic actuator;
a displacement control unit that controls displacement of the hydraulic pump according to a control input;
a displacement sensor that senses a displacement actual measured value of the hydraulic pump; and
a controller that acquires a displacement target value of the hydraulic pump and outputs the control input according to the displacement target value to the displacement control unit, wherein
the controller stores therein a mathematical model for predicting the displacement of the hydraulic pump, and
the controller is configured to
compute a displacement predicted value of the hydraulic pump by using the mathematical model,
compute the control input that is optimum, on a basis of the displacement predicted value and a constraint on the control input,
compute an evaluation value on a basis of the displacement target value and the displacement actual measured value, and
change the constraint on the control input depending on the evaluation value.

2. The control system of a work machine according to claim 1, wherein
a threshold for the evaluation value is stored in the controller, and
the controller is configured to
set a value of the constraint on the control input depending on a magnitude relation between the evaluation value and the threshold, and
employ a first-order system for a change characteristic of the constraint on the control input with respect to time.

3. The control system of a work machine according to claim 1, wherein
a constraint table that defines a characteristic of the constraint on the control input that continuously changes with respect to the evaluation value is stored in the controller, and
the controller is configured to refer to the constraint table and set the value of the constraint on the control input on a basis of the evaluation value.

4. The control system of a work machine according to claim 1, wherein
the controller is configured to use a deviation between the displacement target value and the displacement actual measured value as the evaluation value.

5. The control system of a work machine according to claim 1, wherein
the controller is configured to
compute the control input such that an evaluation function including a sum of squares of a deviation between the displacement target value and the displacement predicted value in a prediction horizon with a predetermined time width becomes minimum, and
use a value of the evaluation function as the evaluation value.

6. The control system of a work machine according to claim 1, wherein
the constraint on the control input includes an upper limit value and a lower limit value of the control input, and
the controller is configured to
set the upper limit value to a first upper limit value when the evaluation value is equal to or larger than a threshold for the upper limit value,
set the upper limit value to a second upper limit value smaller than the first upper limit value when the evaluation value is smaller than the threshold for the upper limit value,
set the lower limit value to a first lower limit value when the evaluation value is equal to or larger than a threshold for the lower limit value, and
set the lower limit value to a second lower limit value larger than the first lower limit value when the evaluation value is smaller than the threshold for the lower limit value.

7. The control system of a work machine according to claim 1, wherein
the controller is configured to update the mathematical model by using the displacement actual measured value and the control input.
